(19) United States
(12) Patent Application Publication
(10) Pub. No.: US 2026/0077407 A1
(43) Pub. Date: Mar. 19, 2026

(54) THREE-DIMENSIONAL METAL PRINTING SYSTEMS, COMPONENTS, METHODS AND MATERIALS FOR USE THEREWITH

(71) Applicant: Action BOX Innovations Inc., Richmond (CA)

(72) Inventors: Oded Aminov, Blaine, MN (US); Alon Aminov, Richmond (CA)

(73) Assignee: Action BOX Innovations Inc., Richmond (CA)

(21) Appl. No.: 19/318,505

(22) Filed: Sep. 4, 2025

Related U.S. Application Data
(60) Provisional application No. 63/695,496, filed on Sep. 17, 2024.

(51) Int. Cl. B22F 10/18; B22F 1/10; B22F 10/64; B22F 12/53; B33Y 10/00; B33Y 40/20

(52) U.S. Cl. CPC B22F 10/18; B22F 1/10; B22F 10/64; B22F 12/53; B33Y 10/00; B33Y 40/20; B22F 2304/10; B22F 2998/10; B22F 2999/00

(57) ABSTRACT

A method of forming a finished metal part includes: forming a printed part via a three-dimensional (3D) printer having an extruder that extrudes a metal paste in a liquid state onto a print bed of the 3D printer to form the printed part, the metal paste including a metal powder and a binder, and the extruder including a nozzle configured to facilitate a flow of a metal paste in the liquid state to positions on a print bed of the 3D printer under control of a 3D positioning system of the 3D printer; converting the printed part to solid form; and forming the finished metal part from the printed part in solid form by a debinding and a sintering via a non-vacuum furnace.

### CROSS-REFERENCE TO RELATED APPLICATIONS

The present U.S. Utility Patent Application claims priority pursuant to 35 U.S. C. § 119(e) to U.S. Provisional Application No. 63/695,496, entitled “THREE-DIMENSIONAL METAL PRINTING SYSTEMS, COMPONENTS, METHODS AND MATERIALS FOR USE THEREWITH”, filed Sep. 17, 2024, which is hereby incorporated herein by reference in its entirety and made part of the present U.S. Utility Patent Application for all purposes.

### BACKGROUND OF THE INVENTION

### Technical Field of the Invention

This invention relates generally to three-dimensional (3D) metal printing systems and particularly to components for use therewith, methodologies and materials used in 3D metal printing and the preparation of finished metal parts that have been 3D printed.

### Description of Related Art

3D printing, also known as additive manufacturing, is a process that creates three-dimensional objects utilizing a digital file. Such methodologies build items layer by layer from a supply of one or more materials, allowing for intricate designs and complex shapes that are often difficult or impossible to achieve with traditional manufacturing methods. 3D printing is used in various industries, including aerospace, automotive, healthcare, and fashion. It enables rapid prototyping, custom manufacturing, and even the production of final products. In healthcare, for example, it can be used to create custom implants and prosthetics.

There are various 3D printing technologies, including Fused Deposition Modeling (FDM), Stereolithography (SLA), and Selective Laser Sintering (SLS). Each method uses different materials and processes to create objects. These materials include plastics, metals, ceramics, and even biological materials for medical applications. The choice of material can influence the object's properties, such as strength, flexibility, and durability.

### BRIEF DESCRIPTION OF THE SEVERAL VIEWS OF THE DRAWING(S)

FIG. 1A is a pictorial/schematic diagram of an example 3D printer;

FIG. 1B is a process/flow diagram of an example method;

FIGS. 1C and 1D are pictorial diagrams of an example extruder;

FIG. 1E is a schematic/flow diagram of an example of a system for finishing 3D printed parts;

FIG. 2A is a flow diagram of an example method; and

FIG. 2B is a flow diagram of an example method.

FIG. 3A is a pictorial diagram of an example 3D printer;

FIG. 3B-3H are pictorial diagrams of an example extruder and portions thereof;

FIG. 3I is a flow diagram of an example method.

### DETAILED DESCRIPTION OF THE INVENTION

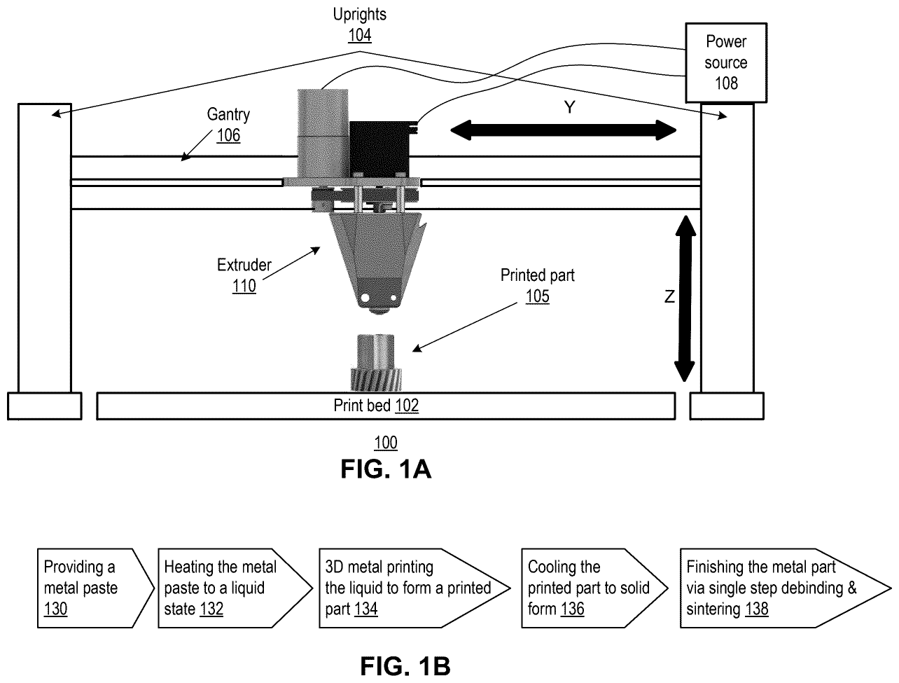

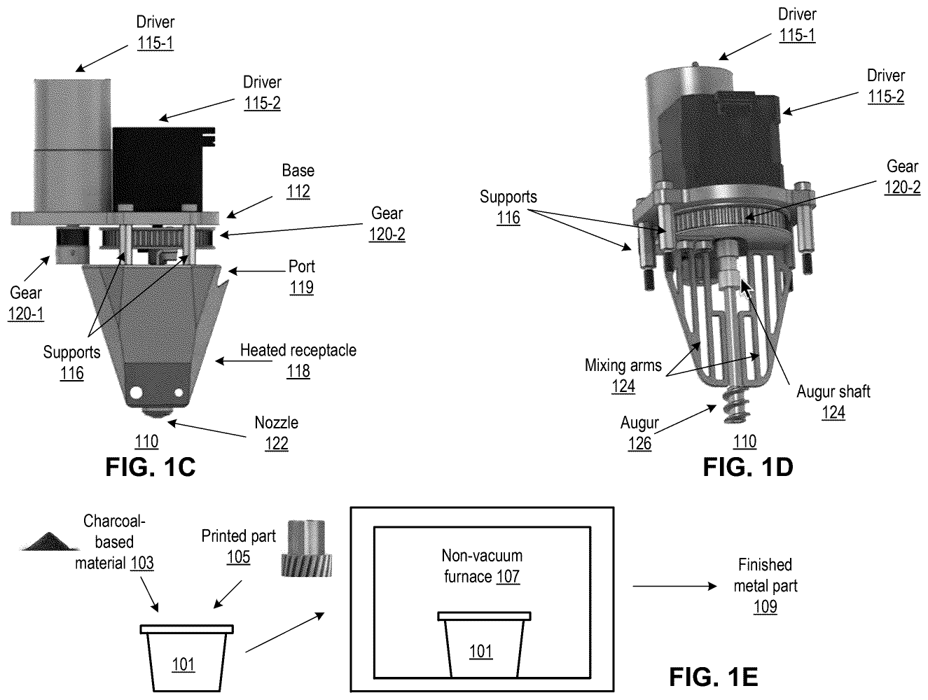

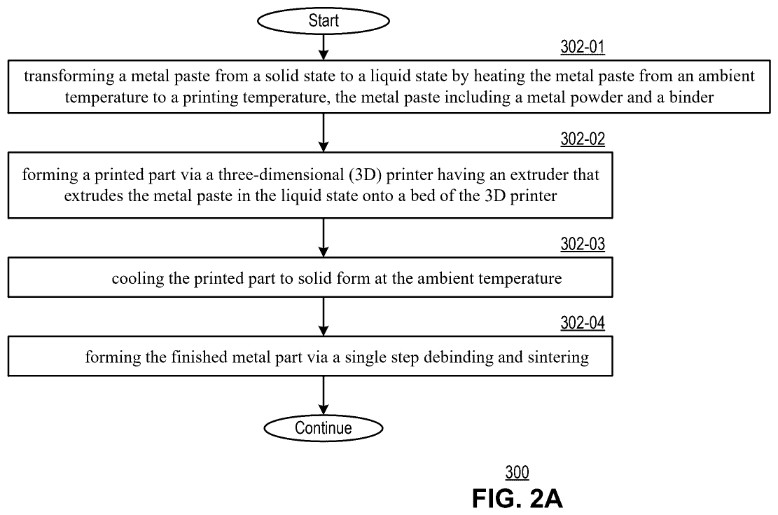

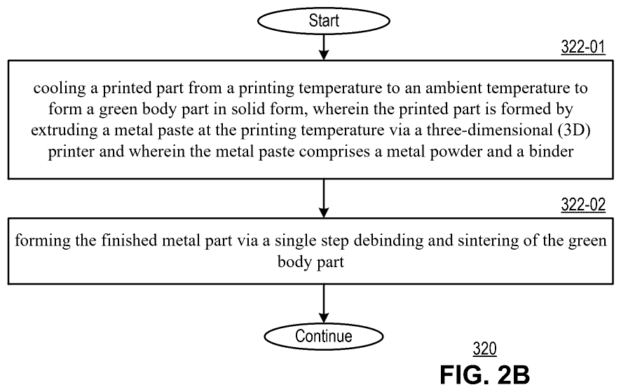

FIG. 1A is a pictorial/schematic diagram of an example 3D printer shown from the front. In particular a 3D printer 100 is shown that includes a 3D positioning system that includes uprights 104, gantry 106 and print bed 102. The 3D printer includes an extruder 110 configured to extrude a metal paste in layers at controlled positions in 3D upon the print bed 102 to form a printed part, an example of which is shown as printed part 105. In the example shown, the extruder 110 includes two drivers that are connected to a power source 108 via wires that are shown schematically, and which in other examples are implemented via a cabling system that conforms with the positioning of the extruder through all possible 3D printing positions of the 3D printer 100. It should also be noted that the printed part 105 shown is merely an example of the wide range of parts that can be 3D printed using the metal paste, extruder, 3D printer and/or the various methodologies discussed herein.

In various examples, the 3D positioning system controls the position of gantry 106 along the Z axis, controls the Y axis position of the extruder 110 along a track in the gantry 106 and controls the position of the print bed 102 along an x axis track (not expressly shown) which, as will be understood by one of ordinary skill, extends into FIG. 1A in this front orientation. While a particular configuration of 3D positioning system is shown, other configurations are likewise possible including similar configurations where the print bed is fixed and the uprights are on tracks, the use of a robotic arm, and/or other 3D positioning systems that control the position of an extruder, such as extruder 110, to controlled positions for 3D printing.

Consider the following example, where an extruder 110 is coupled to the 3D positioning system of a 3D printer, such as 3D printer 100, includes:
at least one driver;
a nozzle configured to facilitate a flow of a metal paste in the liquid state to positions on the print bed under control of the 3D positioning system, the metal paste including a metal powder and a binder;
a heating receptacle coupled to the nozzle and configured to transform the metal paste from a solid state to a liquid state by heating the metal paste from an ambient temperature to a printing temperature;
an auger driven by the at least one driver to rotate within the heating receptacle to provide the metal paste in the liquid state to the nozzle; and
a mixer driven by the at least one driver to rotate about the auger to limit the separation of the binder and the metal powder.

In addition or alternative to any of the foregoing, the metal powder includes one or more of: copper, bronze, silver, gold, iron, nickel or cobalt.

In addition or alternative to any of the foregoing, the metal powder has a particle size of 44 microns or less.

In addition or alternative to any of the foregoing, the metal powder has a higher standard free energy of formation of oxides than carbon at a temperature and pressure used for the single step debinding and sintering.

In addition or alternative to any of the foregoing, the binder includes polyethylene glycol (PEG) and stearic acid (SA).

In addition or alternative to any of the foregoing, the binder includes greater than 60 percent PEG and less than 40 percent SA.

In addition or alternative to any of the foregoing, the mixer is driven to rotate at a rotational velocity about the auger that differs from a rotational velocity of the auger.

In addition or alternative to any of the foregoing, the mixer is driven to rotate via a first driver of the at least one driver and the auger is driven to rotate via a second driver of the at least one driver.

In addition or alternative to any of the foregoing, the mixer maintains a continuing supply of the metal paste in the liquid state to the auger during extrusion.

In addition or alternative to any of the foregoing, the printing temperature is within a range of 60 degrees C. and 100 degrees C.

In addition or alternative to any of the foregoing, the 3D printer extrudes the metal paste in the liquid state to the bed of the 3D printer in ambient atmospheric conditions.

In various examples, a 3D printer operates by extruding a metal paste that includes:
a metal powder; and
a binder that includes polyethylene glycol (PEG) and stearic acid (SA);
wherein the metal paste transforms from a solid at an ambient temperature into a liquid at printing temperature.

In addition or alternative to any of the foregoing, the metal powder includes one or more of: copper, bronze, silver, gold, iron, nickel or cobalt.

In addition or alternative to any of the foregoing, the metal powder has a particle size of 44 microns or less.

In addition or alternative to any of the foregoing, once printed by the 3D printer, the metal paste forms a solid part when cooled to the ambient temperature.

In addition or alternative to any of the foregoing, wherein a finished metal part can be formed from the solid part via a single step debinding and sintering.

In addition or alternative to any of the foregoing, the solid part can be reused by heating to printing temperature prior to the single step debinding and sintering.

In addition or alternative to any of the foregoing, the single step debinding and sintering is performed via heating in a non-vacuum furnace in a presence of a powdered coconut charcoal mixture.

In addition or alternative to any of the foregoing, the metal powder comprises 85% or more of the metal paste and the binder comprises 15% or less of the metal paste.

In addition or alternative to any of the foregoing, the binder includes greater than 60 percent PEG and less than 40 percent SA.

In addition or alternative to any of the foregoing, the printing temperature is within a range of 60 degrees C. and 100 degrees C.

Further examples relating to the extruder 110, the metal paste as well as the 3D printing and finishing processes, including many variations and optional functions and features are presented in conjunction with FIG. 1B-1E, 2A-2B and 3A-3C that follow.

FIG. 1B is a process/flow diagram of an example method. In particular, an example method of 3D printing and finishing a printed part is presented that can be used in conjunction with one or more functions and features described herein.

Step 130 includes providing a metal paste for use in a 3D metal printer. In various examples, the metal paste can be provided in a solid state, at ambient temperature (such as 20-25 degrees C or higher, depending on the environment) and/or in non-hermetic (e.g., normal atmospheric) conditions. In accordance with the example presented in conjunction with FIG. 1A, the metal paste is provided to the extruder 110 which, among other functions, serves as a vessel for the paste.

In step 132, the metal paste is heated into a liquid state. In various examples, the extruder 110 provides an electrical heating element or other mechanism to heat metal paste. The metal paste changes from a solid state to a liquid state at printing temperature (e.g., 60-100 degrees C). The metal paste contains a powdered metal and a binder that can be extruded as a liquid at the printing temperature, that hardens into a solid as it cools. The binder can include 65% or greater Polyethylene glycol (PEG) (e.g., having a molecular weight between 2000 and 20000) and 35% or less Stearic acid (SA). The metal paste can comprise 15% or less of binder (by weight) and 85% (by weight) or more of powdered metal. The powder metal can comprise a spherical gas atomized powder of 44 micron size (or smaller), e.g., 325 mesh. Furthermore, lesser percentages of powdered metal and corresponding higher percentages of binder can be employed in other examples depending on, for example, the composition and/or the specific gravity of the metal powder, the viscosity of the binder and the desired viscosity of the metal paste at the printing temperature.

The metal powder can be copper, bronze, silver, gold, iron, cobalt, nickel, stainless steel (e.g., 316L, 17-4 PH), a titanium alloy (e.g., Ti-6Al-4V), an aluminum alloy (e.g., AlSi10Mg), Inconel (e.g., Inconel 625, Inconel 718), cobalt-chrome (CoCr), tool steel (e.g., A2, D2, H13), a nickel alloy (e.g., Ni—Cr, Invar 36), a copper alloy, maraging steel (e.g., MS1) or other metal powder and combinations thereof with, for example, slight/slow oxidation, an ignition temperature above the printing temperature and/or having higher standard free energy of formation of oxides than carbon at a debinding/sintering temperature and/or partial pressure of oxygen.

Step 134 includes 3D metal printing of the metal paste in the liquid state to form a printed part. In various examples, the 3D metal printer includes an extruder having:
A heated receptacle for holding and heating the metal paste above the printing temperature (as described above) and further having a nozzle;
An auger, provided within the heating receptacle, rotatably driven to facilitate extrusion of the metal paste through the nozzle and furthermore to control the flow rate of the material through the nozzle; and
A mixing mechanism provided within the heating receptacle, rotatably driven to rotate about the auger—so as to maintain a constant supply of metal paste around the auger during the extrusion, to limit separation of the metal paste when the auger is not rotating and/or to limit separation of the metal paste during extrusion.
   In operation, the binder enables the formation of liquid paste for flow through the nozzle of the extruder of the 3D printer—while forming the 3D printed part. In various examples, the auger and the mixing mechanism can be driven at different rotational velocities, can be driven by different drivers and can be driven in either the same or differing directions. The augur can run at a higher speed than the mixer or vice versa. Furthermore, in various examples, the mixing mechanism can have mixing wings/arms that are aligned parallel to the central axis of the augur, however other mixing mechanisms are likewise possible.

Step 136 includes cooling the printed part to solid form (which can also be referred to as a solid part or 3D printed part) at ambient temperature. At this stage the printed part in solid form can be considered to be a green metal part at room temperature. Furthermore, in various examples the metal paste of the printed part is recyclable and can be reused by prior to sintering and debinding in the next step.

Step 138 includes forming the finished 3D metal part by heating in a non-vacuum furnace. In this fashion, the green metal part is sintered and debound in a single step—avoiding the separate step of forming a brown body part. In various examples, the heating uses powdered charcoal-based material—such as powdered coconut charcoal—which can be mixed with a filler such as alumina powder.

FIGS. 1C and 1D are pictorial diagrams of an example extruder. In the example shown in FIG. 1C, the extruder 110 includes base 112 that supports, via a plurality of supports 116, a heated receptacle 118 for holding and heating (e.g., via a heating element) a metal paste provided to the extruder via port 119 and that is extruded via the nozzle 122 during 3D printing. The base 112 also supports a driver 115-2 that rotates an auger within the heated receptacle 118 that is controlled so as to feed the metal paste to the nozzle 122. The base 112 also supports a driver 115-1 having a shaft coupled to gear 120-1 that rotates gear 120-2 via a belt (removed from this image to expose the gears 120-1 and 120-2) that is coupled to a mixing mechanism (which can be referred to as a mixer).

As shown in FIG. 1D (with the heated receptable removed), the auger 126 is driven by auger shaft 124 coupled to the driver 115-2. The gear 120-2 has bearings allowing the gear 120-2, which is coupled to a mixer having mixing arms 124, to rotate about the augur shaft 124 of the auger 126. The rotation of the mixing arms 124 operates so as to limit separation of the metal paste (e.g., the separation of the binder from the powdered metal) and to provide a supply of the metal paste to the auger for extrusion.

It should be noted that while the examples of the extruder 110 illustrated above employ two different drivers to separately drive the mixing arms 124 and the auger 126, in other examples, a single driver could drive both the mixing arms 124 and the auger 126 via a configuration with two belts and/or additional gears.

FIG. 1E is a schematic/flow diagram of an example of a system for finishing 3D metal parts. As previously discussed, printed part 105 is cooled to solid form at ambient temperature. At this stage, the printed part in solid form can be considered to be a green metal part at room temperature. In prior systems, a two-step process is required that includes a separate debinding step (generally for many hours) followed by a long vacuum sintering.

In various examples presented herein however, the finished 3D metal part can be formed directly by heating in a non-vacuum furnace 107 (which can also be referred to as an oven) in as little as 2.5 hours. In various examples, the heating uses powdered charcoal-based material 103 that includes powdered coconut charcoal—mixed with a filler such as alumina powder. In this fashion, the green metal part is sintered and debound in a single step to form the finished metal part 109—avoiding the separate step of forming of a brown body by debinding prior to sintering.

In various examples, the printed part 105 is placed in a crucible 101 and covered or otherwise surrounded with the powdered charcoal-based material 103. The crucible 101 is then placed within the non-vacuum furnace 107 for debinding and sintering. The temperature of the non-vacuum furnace 107 is gradually ramped-up in a first phase of this operation. This first phase can last, for example 30-45 minutes, and can allow the air trapped within the coconut powder to promote the debinding of the printed part 105. During a second phase of this operation, the temperatures reaches and is held at a sintering temperature (e.g., 1070 degrees C.). This second phase can last 1.5 to 3 hours for example. It can be noted that any metal that has a standard free energy of formation of oxide (ΔG°) which is less negative than that of carbon's (at a given temperature, e.g., the sintering temperature) will be reducible by carbon at a given temperature. See e.g., https://web.mit.edu/2.813/www/readings/Ellingham_diagrams.pdf. At the sintering temperature, the carbon in the powdered charcoal-based material 103 (e.g., the powdered coconut charcoal) attracts the oxygen from the printed part, converting it to one or more carbon-oxygen compounds such as carbon dioxide and/or carbon monoxide which can be vented from the non-vacuum furnace 107. In a final phase, the finished metal part is allowed to naturally cool over a period of 2 hours. It should be noted that the time periods for each phase, and the sintering temperature discussed above can correspond to a metal paste that includes 93% powdered copper by weight. These time periods and sintering temperatures can be adjusted based on the composition of the metal paste and/or the dimensions and shape of the part.

It should be noted again that the printed part 105 shown is merely an example of the wide range of printed parts that can be 3D printed using the metal paste, extruder, 3D printer and/or the various methodologies presented herein.

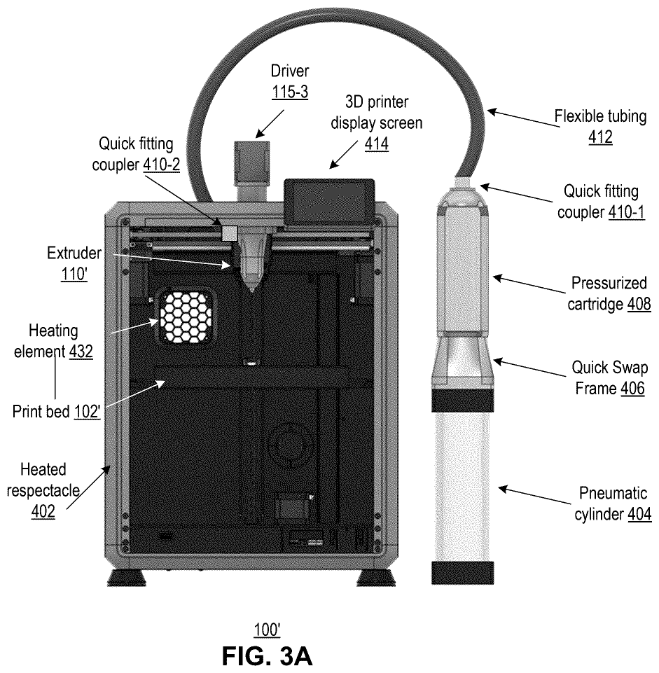

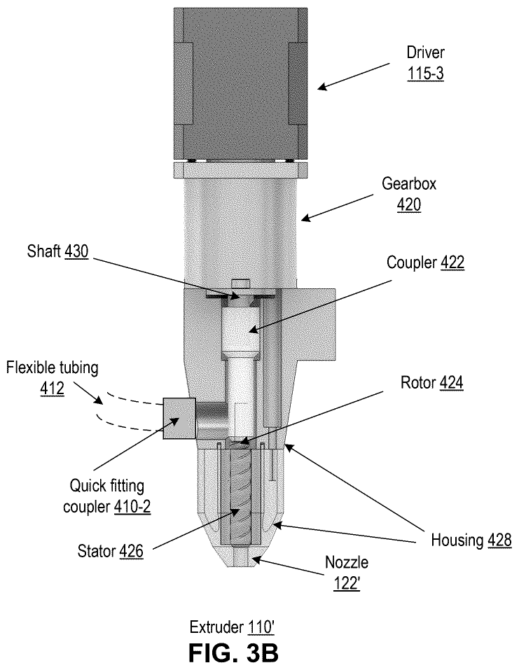

FIG. 2A is a flow diagram of an example method. In particular, a method 300 is presented that can be used in combination with one or more functions and features described herein. Step 302-1 includes transforming a metal paste from a solid state to a liquid state by heating the metal paste from an ambient temperature to a printing temperature, the metal paste including a metal powder and a binder. Step 302-2 includes forming a printed part via a three-dimensional (3D) printer having an extruder that extrudes the metal paste in the liquid state onto a print bed of the 3D printer. Step 302-3 includes cooling the printed part to solid form at the ambient temperature. Step 302-4 includes forming the finished metal part via a single step debinding and sintering.

In addition or alternative to any of the foregoing, the metal powder includes one or more of: copper, bronze, silver, gold, iron, nickel or cobalt.

In addition or alternative to any of the foregoing, the metal powder has a particle size of 44 microns or less.

In addition or alternative to any of the foregoing, the metal powder has a higher standard free energy of formation of oxides than carbon at a temperature and pressure used for the single step debinding and sintering.

In addition or alternative to any of the foregoing, the binder includes polyethylene glycol (PEG) and stearic acid (SA).

In addition or alternative to any of the foregoing, the binder includes greater than 60 percent PEG and less than 40 percent SA.

In addition or alternative to any of the foregoing, extruder further includes a heating receptacle configured to heat the metal paste from the ambient temperature to the printing temperature;

In addition or alternative to any of the foregoing, the extruder facilitates a flow of the metal paste in the liquid state through a nozzle of the extruder while limiting separation of the binder and the metal powder.

In addition or alternative to any of the foregoing, the extruder further includes an auger driven to rotate within the heating receptacle to provide the metal paste in the liquid state to the nozzle of the extruder.

In addition or alternative to any of the foregoing, the extruder further includes a mixer driven to rotate about the auger to limit the separation of the binder and the metal powder.

In addition or alternative to any of the foregoing, the mixer is driven to rotate at a rotational velocity about the auger that differs from a rotational velocity of the auger.

In addition or alternative to any of the foregoing, the mixer is driven to rotate via a first driver and the auger is driven to rotate via a second driver.

In addition or alternative to any of the foregoing, the mixer maintains a supply of the metal paste in the liquid state to the auger during extrusion.

In addition or alternative to any of the foregoing, the printing temperature is within a range of 60 degrees C. and 100 degrees C.

In addition or alternative to any of the foregoing, the extruder extrudes the metal paste in the liquid state to the bed of the 3D printer in ambient atmospheric conditions.

In addition or alternative to any of the foregoing, the printed part in solid form is a green body part and the single step debinding and sintering is performed without creation of a brown body part.

In addition or alternative to any of the foregoing, the single step debinding and sintering is performed via heating in a non-vacuum furnace.

In addition or alternative to any of the foregoing, the heating in the non-vacuum furnace is performed in a presence of a powdered charcoal.

In addition or alternative to any of the foregoing, the powdered charcoal includes powdered coconut charcoal mixture.

In addition or alternative to any of the foregoing, the powdered coconut charcoal mixture includes an alumina powder.

FIG. 2B is a flow diagram of an example method. In particular, a method 320 is presented that can be used in combination with one or more functions and features described herein. Step 322-1 includes cooling a printed part from a printing temperature to an ambient temperature to form a green body part in solid form, wherein the printed part is formed by extruding a metal paste at the printing temperature via a three-dimensional (3D) printer and wherein the metal paste comprises a metal powder and a binder. Step 322-2 includes forming the finished metal part via a single step debinding and sintering of the green body part.

In addition or alternative to any of the foregoing, the metal powder includes one or more of: copper, bronze, silver, gold, iron, nickel or cobalt.

In addition or alternative to any of the foregoing, the metal powder has a particle size of 44 microns or less.

In addition or alternative to any of the foregoing, the metal powder has a higher standard free energy of formation of oxides than carbon at a temperature and pressure used for the single step debinding and sintering.

In addition or alternative to any of the foregoing, the binder includes polyethylene glycol (PEG) and stearic acid (SA).

In addition or alternative to any of the foregoing, the binder includes greater than 60 percent PEG and less than 40 percent SA.

In addition or alternative to any of the foregoing, the printing temperature is within a range of 60 degrees C. and 100 degrees C.

In addition or alternative to any of the foregoing, the single step debinding and sintering is performed without creation of a brown body part.

In addition or alternative to any of the foregoing, the single step debinding and sintering is performed via heating in a non-vacuum furnace.

In addition or alternative to any of the foregoing, the heating in the non-vacuum furnace is performed in a presence of a powdered charcoal.

In addition or alternative to any of the foregoing, the powdered charcoal includes powdered coconut charcoal mixture.

In addition or alternative to any of the foregoing, the powdered coconut charcoal mixture includes an alumina powder.

Consider the following additional examples having other functions/features that can be used in addition or the alternative to any or all of features/elements described in the examples above. In particular, a 3D printer system can operate by:
forming a printed part via a three-dimensional (3D) printer having an extruder that extrudes a metal paste in a liquid state onto a print bed of the 3D printer to form the printed part, the metal paste including a metal powder and a binder, and the extruder including a nozzle configured to facilitate a flow of a metal paste in the liquid state to positions on a print bed of the 3D printer under control of a 3D positioning system of the 3D printer;
converting the printed part to solid form; and
forming the finished metal part from the printed part in solid form by a debinding and a sintering via a non-vacuum furnace.

In addition or alternative to any of the foregoing, the metal powder includes one or more of: copper, bronze, silver, gold, iron, nickel or cobalt.

In addition or alternative to any of the foregoing, the metal powder has a particle size of 74 microns or less (e.g., mesh 200).

In addition or alternative to any of the foregoing, the metal powder has a higher standard free energy of formation of oxides than carbon at a temperature and pressure used for the debinding and/or sintering via the non-vacuum furnace.

In addition or alternative to any of the foregoing, the binder includes Hydroxypropyl methylcellulose (HPMC) and polyethylene glycol (PEG).

In addition or alternative to any of the foregoing, the metal paste includes, by weight, between 85-92% of the metal powder, between 2-3% of the HPMC, between 0.5 - 3% of the PEG and a remainder in water.

In addition or alternative to any of the foregoing, the 3D print bed is positioned within a heated receptacle configured to heat the metal paste from the ambient temperature during printing to a drying temperature.

In addition or alternative to any of the foregoing, the extruder facilitates a flow of the metal paste in the liquid state through the nozzle of the extruder while limiting separation of the binder and the metal powder.

In addition or alternative to any of the foregoing, the extruder includes a pump that provides the metal paste in the liquid state to the nozzle of the extruder to provide a controlled extrusion of the metal paste in a presence of expansion.

In addition or alternative to any of the foregoing, the pump includes:
a driver;
a housing coupled to the nozzle;
a stator within the housing; and
a rotor, coupled to the driver via a coupler, and configured to rotate within the stator to controllable extrude the metal paste from the nozzle.

In addition or alternative to any of the foregoing, the driver includes a motor and a gearbox that drive the coupler to facilitate rotation and translation of the rotor within the stator.

In addition or alternative to any of the foregoing, the stator comprises a monolithic block of cast polyurethane.

In addition or alternative to any of the foregoing, the monolithic block of cast polyurethane has a hardness between 70-A to 80-A and includes one or more flat exterior surfaces that mate with the housing to constrain rotation movement of the stator within the housing.

In addition or alternative to any of the foregoing, the housing is constructed of two parts that fit together via one or more seams so as to prevent leakage of the metal paste from the seams under a pressure of extrusion.

In addition or alternative to any of the foregoing, the housing restrains translational movement of the stator within the housing.

In addition or alternative to any of the foregoing, the metal paste is fed to the extruder from a pressurized cartridge that is interchangeably engaged to the 3D printer.

In addition or alternative to any of the foregoing, the metal paste is fed to the extruder from the pressurized cartridge via a hermetically sealed feedline.

In addition or alternative to any of the foregoing, the metal paste is driven to the extruder from the pressurized cartridge via a pneumatic cylinder.

In addition or alternative to any of the foregoing, the pneumatic cylinder exerts a fed pressure on the pressurized cartridge of between 33 to 38 pounds per square inch.

In addition or alternative to any of the foregoing, the pressurized cartridge is configured to store the metal paste in ambient conditions.

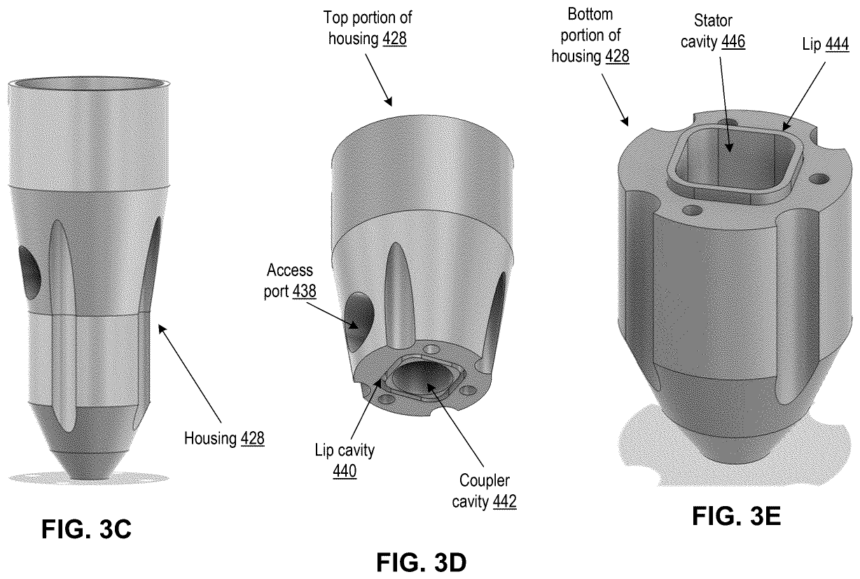

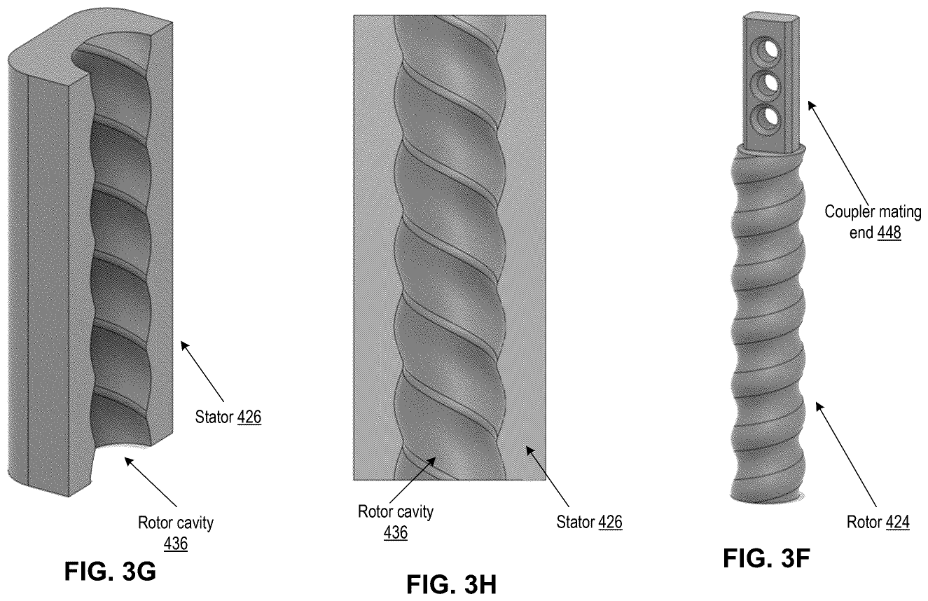

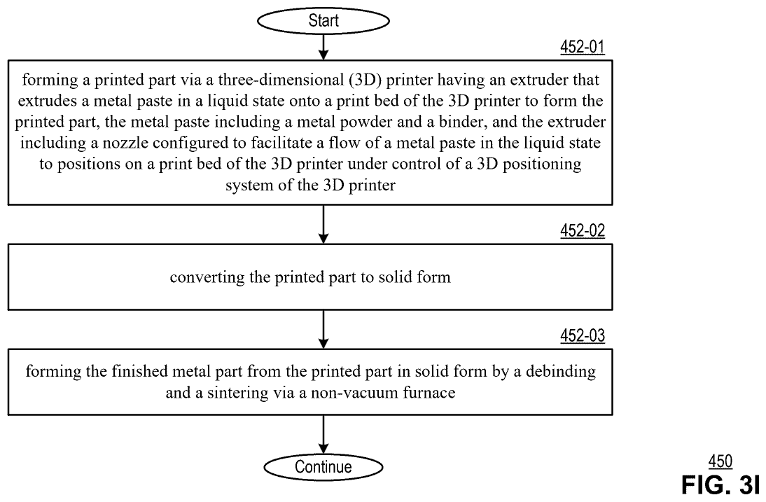

FIG. 3A is a pictorial diagram 100′ of an example 3D printer that can be used in addition or alternative to any of the 3D printing systems and methods previously described. The 3D printer includes a display screen 414 that, for example, presents a graphical user interface or other user interface to facilitate the operation of the printer. In this example, the print bed 102′ is contained within a heated receptacle 402 that contains heating element 432 that heats the environment within the heated receptacle to a temperature within the range, for example, of 40-100 degrees C. in order to dry and convert the printed part into solid form via evaporation of the solvent contained in the metal paste. In further examples, greater or lesser temperatures could be likewise be employed. Furthermore, the metal paste is contained in a pressurized cartridge 408 that is driven by pneumatic cylinder 404 to provide the metal paste to the extruder 110′ via the flexible tubing 412. The flexible tubing 412 includes a quick fitting 410-1 that connects to the pressurized cartridge 408 and a quick fitting 410-2 that connects to the extruder 110′ via mating connectors in the pressurized cartridge and the extruder 110′ that each include a self-closing valve. In various examples, the quick fitting 410-1 and the mating connector in the pressurized cartridge 408 both contain a one-way valve that prevents drying of the material in both the cartridge and the tubing when they are disconnected. Likewise, the quick fitting 410-2 and/or the mating connector in the extruder 110′ can include a one-way valve. The quick swap frame 406 and the quick fitting coupler 410-1 allow empty pressurized cartridges 408 to be removed and new pressurized cartridges 408 to be swapped in to promote seamless operation of the system without significant loss of seal and/or to prevent drying of the metal paste when a cartridge is disconnected. In operation, the driver 115-3 helps facilitate the extrusion of the metal paste through the nozzle of the extruder 110′.

Consider the following examples of an extrusion-based metal printing system where the metal paste is a water-based hydroxypropyl methylcellulose (HPMC)/PEG hydrogel bronze paste compatible with storage/dispensing cartridges. In particular, the extrusion of metal-powder pastes can benefit from binders/plasticizers that suppress phase separation during residence in cartridges and while being dispensed. HPMC is a readily available chemical which forms a water-swollen hydrogel that provides cohesion and anti-settling behavior in aqueous pastes. The Polyethylene glycol (e.g., PEG-400) can act as a plasticizer/humectant to reduce drying stress and cracking in printed layers. Bronze paste formulated binders such as these examples can provide a printer-ready, cartridge-stored paste that can maintain storage stability, crack-free drying, and consistent metering (e.g., with a progressive-cavity and/or other metering pump).

In various examples a printable bronze paste comprises bronze powder, an aqueous HPMC hydrogel binder phase, and PEG-400 as a plasticizer/humectant. In various embodiments, the paste contains 85-92 % metal solids (by weight), 2-3 % HPMC (of the total paste by weight), and 0.5-3.0% PEG-400 (by weight), with the balance of the weight being water. This paste exhibits low separation during storage and crack-resistant drying of printed layers and facilitates storage/dispensing via oxygen-barrier cartridges and furthermore the 3D printing, debinding and sintering the paste into finished bronze parts.

Further improvements to technology via this example of 3D metal printing system include:
the mitigation of slumping of the part during the debinding which can be implemented via a non-vacuum oven;
Anti-separation during storage and dispense (stable bead geometry);
Crack-resistant drying of the printed part with 0.2-1.0 mm layers at the ambient conditions within the heated receptacle;
Compatibility with progressive-cavity metering for accurate volumetrics; and
Barrier-cartridge storage for months or shelf life.

In various examples, the metal paste expands due to entrapped or dissolved gas within the hydrogel component as the paste passes forward through small cavities of the system. To prevent the expansion from extruding the paste through the nozzle uncontrollably, the extruder 110′ includes a metering pump such as a Moineau pump or other progressive-cavity metering apparatus (or expressed more simply as a “pump”), that passes forward a specific/controlled volume of material. Prior art Moineau pumps can be expensive to manufacture due to their reliance on stators that are implemented as elastomer sleeves bonded or vulcanized into the steel tube that form the stator “housing. ” Such constructions require preparing a metal tube, adhesive or surface treatment, and a vulcanization/bonding step, followed by finishing steps that increase material and manufacturing cost. Even “easy-change” variants retain a separate stator housing and insert. In various examples described herein, a stator is implemented that enables the metering pump of the extruder 110′ to be used in low-cost systems.

In various examples, the pump of the extruder 110′ is not self-priming, and the metal paste is therefore force fed into it. In these examples, the flexible tubing 412 that provides the connection between the pressurized cartridge 408 and the extruder 110′ can be hermetically sealed. Further, the pneumatic cylinder 404 is coupled to the quick swap frame 406 to enable a quick change —-allowing a user to quickly slide-in a cartridge and pressurize it, to keep metal paste flowing to the extruder for seamless operation. The pneumatic cylinder 404 can have an inner diameter 63 mm that is pressurized via a piston to a pressure range, such as 33-38 PSI, in order to provide sufficient feed pressure to the extruder 110′, without over-pressurizing the paste inside of the pump—which could break the stator seal and cause leaks.

In various examples, the pressurized cartridge 408 is a plastic cartridge filled with metal paste material and sealed from the bottom with a built-in plunger that can withstand the pressure from the pneumatic cylinder 404. The top of the pressurized cartridge 408 has a quick connect adapter that mates with the quick fitting coupler 410-01 in order to facilitate simple installation. This adapter can be self-sealing so that it closes automatically when the cartridge is disconnected to preventing the metal paste from drying when cartridge is not in use.

FIG. 3B is a pictorial diagram of an example extruder 110′ that can be used in addition or alternative to any of the 3D printing systems and methods previously described. This extruder 110′ includes a housing 428 having top and bottom portions (e.g., pieces), each with opposing front and back sides that can be implemented bisymmetrically - with the front and back sides of each piece being mirror images of one another. The front sides of the housing 428 have been removed in order to reveal the stator 426, the coupler 422 and the shaft 430 contained therein. In various examples, the driver 115-3 is implemented via a stepper motor or other motor design that drives the gearbox 420. The shaft 430 of the gearbox drives a coupler 422 that is flexible to accommodate the rotation and translation of the rotor 424.

In various examples, the top and bottom pieces/portions of the housing 420 can each be implemented monolithically, but mate together so as to form the full housing 428 in a two-part design as shown in FIG. 3C. As shown in FIG. 3D, the top portion of the housing 428 includes an access port 438 that can couple to a quick connect adapter that mates with quick fitting coupler 410-2. The top portion of the housing 428 further includes a coupler cavity 442 for housing the coupler 422 during operation and a lip cavity 440 for mating with a lip 444 of the bottom portion of the housing 428 as shown in FIG. 3E. The bottom portion of the housing 428 further includes a stator cavity 446 configured to hold the stator 426. The top and bottom pieces of the housing fit together via the lip 444 and lip cavity 440 to not only align the fit, but also to prevent leaking of the high pressure metal paste from the seam between the top and bottom portions of the housing 428.

An example of the rotor 424 is shown in FIG. 3F. In the example shown, the rotor 424 includes a coupler mating end 448 to mate with the coupler 422 and can be constructed of stainless steel to prevent corrosion in water while maintaining sufficient strength and wear resistance during periods of operation. The stator 426 can be constructed of a single monolithic block of cast polyurethane with hardness 70-A to 80-A to ensure a proper seal with the rotor 424. In the examples shown, the stator 426 has multiple flat faces so that its rotation is constrained within the housing 428—but can slide in and out of the housing for cleaning and/or replacement.

In various examples, the stator 426 includes a rotor cavity 436 that can be configured as a double-helical bore, as shown in cross-section in FIGS. 3F and 3G, to surround the rotor 424 and facilitate the controlled extrusion of the metal paste during operation of the pump. The stator 426 can be formed directly by casting in silicone tooling and can be configured to slide into the rigid bottom portion of the housing 428 so as to radially support the polymer body of the stator 426 during operation—with no elastomer-to-metal bonding required. End-region features of the stator 426 provide sealing and axial retention. The integral outer flat side faces of the stator 426 can be configured to correspond to flats in the housing 428 to prevent stator rotation during operation of the rotor 424. This architecture reduces part count, eliminates bonding operations, and enables low-cost manufacture and rapid field replacement in applications where periodic stator changeover is acceptable.

FIG. 3I is a flow diagram of an example method. In particular, a method 450 is presented that can be used in combination with one or more functions and features described herein. Step 452-01 includes forming a printed part via a three-dimensional (3D) printer having an extruder that extrudes a metal paste in a liquid state onto a print bed of the 3D printer to form the printed part, the metal paste including a metal powder and a binder, and the extruder including a nozzle configured to facilitate a flow of a metal paste in the liquid state to positions on a print bed of the 3D printer under control of a 3D positioning system of the 3D printer. Step 452-02 includes converting the printed part to solid form. Step 452-03 includes forming the finished metal part from the printed part in solid form by a debinding and a sintering via a non-vacuum furnace.

In addition or alternative to any of the foregoing, the metal powder includes one or more of: copper, bronze, silver, gold, iron, nickel or cobalt.

In addition or alternative to any of the foregoing, the metal powder has a particle size of 74 microns or less (e.g., mesh 200).

In addition or alternative to any of the foregoing, the metal powder has a higher standard free energy of formation of oxides than carbon at a temperature and pressure used for the debinding and/or sintering via the non-vacuum furnace.

In addition or alternative to any of the foregoing, the binder includes Hydroxypropyl methylcellulose (HPMC) and polyethylene glycol (PEG).

In addition or alternative to any of the foregoing, the metal paste includes, by weight, between 85-92% of the metal powder, between 2-3% of the HPMC, between 0.5 - 3% of the PEG and a remainder in water.

In addition or alternative to any of the foregoing, the 3D print bed is positioned within a heated receptacle configured to heat the metal paste from the ambient temperature during printing to a drying temperature.

In addition or alternative to any of the foregoing, the extruder facilitates a flow of the metal paste in the liquid state through the nozzle of the extruder while limiting separation of the binder and the metal powder.

In addition or alternative to any of the foregoing, the extruder includes a pump that provides the metal paste in the liquid state to the nozzle of the extruder to provide a controlled extrusion of the metal paste in a presence of expansion.

In addition or alternative to any of the foregoing, the pump includes:
a driver;
a housing coupled to the nozzle;
a stator within the housing; and
a rotor, coupled to the driver via a coupler, and configured to rotate within the stator to controllable extrude the metal paste from the nozzle.

In addition or alternative to any of the foregoing, the driver includes a motor and a gearbox that drive the coupler to facilitate rotation and translation of the rotor within the stator.

In addition or alternative to any of the foregoing, the stator comprises a monolithic block of cast polyurethane.

In addition or alternative to any of the foregoing, the monolithic block of cast polyurethane has a hardness between 70-A to 80-A and includes one or more flat exterior surfaces that mate with the housing to constrain rotation movement of the stator within the housing.

In addition or alternative to any of the foregoing, the housing is constructed of two parts that fit together via one or more seams so as to prevent leakage of the metal paste from the seams under a pressure of extrusion.

In addition or alternative to any of the foregoing, the housing restrains translational movement of the stator within the housing.

In addition or alternative to any of the foregoing, the metal paste is fed to the extruder from a pressurized cartridge that is interchangeably engaged to the 3D printer.

In addition or alternative to any of the foregoing, the metal paste is fed to the extruder from the pressurized cartridge via a hermetically sealed feedline.

In addition or alternative to any of the foregoing, the metal paste is driven to the extruder from the pressurized cartridge via a pneumatic cylinder.

In addition or alternative to any of the foregoing, the pneumatic cylinder exerts a fed pressure on the pressurized cartridge of between 33 to 38 pounds per square inch.

In addition or alternative to any of the foregoing, the pressurized cartridge is configured to store the metal paste in ambient conditions.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a”and “c”, “b”and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method of forming a finished metal part, the method comprising:
forming a printed part via a three-dimensional (3D) printer having an extruder that extrudes a metal paste in a liquid state onto a print bed of the 3D printer to form the printed part, the metal paste including a metal powder and a binder, and the extruder including a nozzle configured to facilitate a flow of a metal paste in the liquid state to positions on a print bed of the 3D printer under control of a 3D positioning system of the 3D printer;
converting the printed part to solid form; and
forming the finished metal part from the printed part in solid form by a debinding and a sintering via a non-vacuum furnace.

2. The method of claim 1, wherein the metal powder includes one or more of: copper, bronze, silver, gold, iron, nickel or cobalt.

3. The method of claim 1, wherein the metal powder has a particle size of 74 microns or less.

4. The method of claim 1, wherein the metal powder has a higher standard free energy of formation of oxides than carbon at a temperature and pressure used for the debinding or sintering via the non-vacuum furnace.

5. The method of claim 1, wherein the binder includes Hydroxypropyl methylcellulose (HPMC) and polyethylene glycol (PEG).

6. The method of claim 5, wherein the metal paste includes, by weight, between 85-92% of the metal powder, between 2-3% of the HPMC, between 0.5-3% of the PEG and a remainder in water.

7. The method of claim 1, wherein the print bed is positioned within a heated receptacle configured to heat the metal paste from the ambient temperature during printing to a drying temperature.

8. The method of claim 1, wherein the extruder facilitates a flow of the metal paste in the liquid state through the nozzle of the extruder while limiting separation of the binder and the metal powder.

9. The method of claim 8, wherein the extruder includes a pump that provides the metal paste in the liquid state to the nozzle of the extruder to provide a controlled extrusion of the metal paste in a presence of expansion.

10. The method of claim 9, wherein the pump includes:
a driver;
a housing coupled to the nozzle;
a stator within the housing; and
a rotor, coupled to the driver via a coupler, and configured to rotate within the stator to controllable extrude the metal paste from the nozzle.

11. The method of claim 10, wherein the driver includes a motor and a gearbox that drive the coupler to facilitate rotation and translation of the rotor within the stator.

12. The method of claim 10, wherein the stator comprises a monolithic block of cast polyurethane.

13. The method of claim 12, wherein the monolithic block of cast polyurethane has a hardness between 70-A to 80-A and includes one or more flat exterior surfaces that mate with the housing to constrain rotation movement of the stator within the housing.

14. The method of claim 10, wherein the housing is constructed of two parts that fit together via one or more seams so as to prevent leakage of the metal paste from the seams under a pressure of extrusion.

15. The method of claim 10, wherein the housing restrains translational movement of the stator within the housing.

16. The method of claim 1, wherein the metal paste is fed to the extruder from a pressurized cartridge that is interchangeably engaged to the 3D printer.

17. The method of claim 16, wherein the metal paste is fed to the extruder from the pressurized cartridge via a hermetically sealed feedline.

18. The method of claim 16, wherein the metal paste is driven to the extruder from the pressurized cartridge via a pneumatic cylinder.

19. The method of claim 18, wherein the pneumatic cylinder exerts a fed pressure on the pressurized cartridge of between 33 to 38 pounds per square inch.

20. The method of claim 16, wherein the pressurized cartridge is configured to store the metal paste in ambient conditions.
